(19) United States
(12) Patent Application Publication
(10) Pub. No.: US 2025/0103670 A1
(43) Pub. Date: Mar. 27, 2025

(54) INFORMATION PROCESSING DEVICE, OUTPUT METHOD, AND STORAGE MEDIUM

(71) Applicant: NEC Corporation, Minato-ku, Tokyo (JP)

(72) Inventors: Tatsuya MATSUOKA, Tokyo (JP); Shinji ITO, Tokyo (JP)

(73) Assignee: NEC Corporation, Minato-ku, Tokyo (JP)

(21) Appl. No.: 18/289,582

(22) PCT Filed: Jun. 21, 2023
(86) PCT No.: PCT/JP2023/023002

§ 371 Date: Nov. 6, 2023

(30) Foreign Application Priority Data
Jan. 24, 2023 (WO) PCT/JP2023/002142

(51) Int. Cl. G06F 17/11

(52) U.S. Cl. CPC G06F 17/11

(57) ABSTRACT

An information processing device 1X mainly includes an output means 15X. The output means outputs, as a predetermined number of solutions, candidates in which a minimum value of a distance between the solutions satisfies a predetermined condition among candidates used to select the predetermined number of solutions, when outputting the predetermined number of solutions, from a plurality of solutions in an optimization problem.

### TECHNICAL FIELD

The present disclosure relates to a technical field of an information processing device, an output method, and a storage medium for performing processing related to an optimization problem.

### BACKGROUND ART

Systems are known that present solutions in optimization problems. For example, Patent Document 1 discloses an optimization system in which a combination (matching) is determined so that transaction conditions desired by a seller and a buyer such as a transaction amount and a transaction price of supplies to be traded are respectively corresponded to, and the matching result is presented. Moreover, Non-Patent Document 1 discloses an algorithm which takes a diverse set of sets in a sense of maximizing a sum of distances.

### PRECEDING TECHNICAL REFERENCES

### Patent Document

Patent Document 1: International Publication Pamphlet No. WO2021/001977
Non-patent Document 1: T. Hanaka, M. Kiyomi, Y. Kobayashi, Y. Kobayashi, K. Kurita, and Y. Otachi, “A framework to design approximation algorithms for finding diverse solutions in combinatorial problems”, arXiv preprints, arXiv:2201.08940, 2022.

### SUMMARY

### Problem to be Solved by the Invention

In a case of seeking a solution of an optimization problem, it may be necessary to output a plurality of solutions with diversity in order to comprehend the whole picture of the optimization problem and alternatives. In this case, when diverse solutions in a sense of maximizing a sum of distances are found based on a method in Non-Patent Document 1, there is a possibility that a plurality of solutions to be output may include solutions with a close distance.

In view of the problems described above, it is one object of the present disclosure to provide an information processing device, an output method, and a storage medium for outputting a plurality of solutions with diversity.

### Means for Solving the Problem

An example aspect of an information processing device including:
an output means configured to output, as a predetermined number of solutions, candidates in which a minimum value of a distance between the solutions satisfies a predetermined condition among candidates used to select the predetermined number of solutions, when outputting the predetermined number of solutions, from a plurality of solutions in an optimization problem.

An example aspect of an output method performed by a computer, the output method including:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.

An example aspect of a recording medium storing a program, the program causing a computer to perform a process including:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.

### Effect of the Invention

It is possible to output solutions with diversity.

### BRIEF DESCRIPTION OF THE DRAWINGS

FIG. 1 illustrates a configuration of an optimization system in a first example embodiment.

FIG. 2 illustrates a hardware configuration of an information processing device.

FIG. 3 illustrates an example of a functional configuration in the first example embodiment.

FIG. 4A illustrates a complete bipartite graph with three points at each at the right side and the left side, and FIG. 4B illustrates an example of the complete bipartite graph with three points at each of a right side and a left side depicted in FIG. 4A.

FIG. 5 is a diagram illustrating a weight w for each branch in the complete bipartite graph with the three points at each of the right side and the left side.

FIG. 6 illustrates presentation solutions which are output when a MWU based algorithm is executed as “k=3” and “δ=4” in the complete bipartite graph illustrated in FIG. 5.

FIG. 7 illustrates a display of a presentation solution display screen which is a screen to be displayed on a display device by the UI control unit.

FIG. 8 illustrates an example of a flowchart which the information processing device 1 executes in the first example embodiment.

FIG. 9 illustrates a configuration of an optimization system in a second example embodiment.

FIG. 10 is a diagram illustrating each relationship among a user, an information processing device, and a terminal device in the second example embodiment.

FIG. 11A is a diagram illustrating a schematic of a matching problem between the patients and the hospitals. FIG. 11B illustrates an example of a data structure of patient information. FIG. 1C illustrates an example of a data structure of hospital information.

FIG. 12 is a functional block diagram of an information processing device according to a third example embodiment.

FIG. 13 illustrates an example of a flowchart which is performed by the information processing device in the third example embodiment.

### EXAMPLE EMBODIMENTS

In the following, example embodiments of an information processing device, an output method, and a storage medium will be described with reference to the accompanying drawings.

### First Example Embodiment

### (1) System Configuration

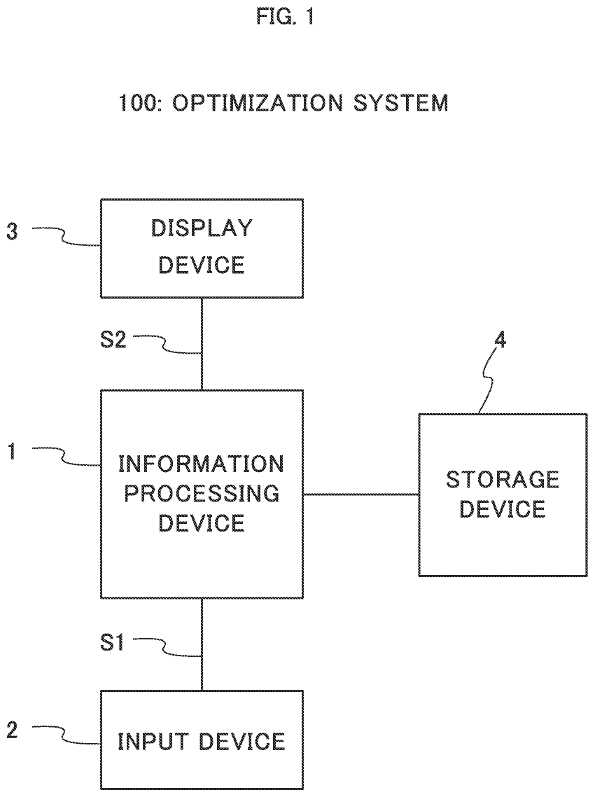

FIG. 1 illustrates a configuration of an optimization system 100 according to a first example embodiment. The optimization system 100 mainly includes an information processing device 1, an input device 2, a display device 3, and a storage device 4.

The information processing device 1 outputs solutions of a combinatorial optimization problem which is designated. In the present example embodiment, the information processing device 1 calculates a plurality of solutions for the combinatorial optimization problem which is designated, and presents a plurality of calculated solutions. In this case, the information processing device 1 generates a plurality of solutions with diversity and dispersion.

Note that the optimization problem may be, for instance, a problem of determining a combination of sellers and buyers of supplies to be traded (and transportation schedules of such supplies), a problem of determining work shifts of employees, or any arbitrary combinatorial optimization problem. The supplies listed above may be fuels such as LNG, steel, machines, electronics, textiles, chemical products, medical items, food products, or any other items.

Moreover, the information processing device 1 performs data communications with the input device 2, the display device 3, and the storage device 4 through a communication network or through wireless or wired direct communications.

The input device 2 is an interface for receiving a user input which is an external input, and for instance, a touch panel, a button, a keyboard, a voice input device, or the like corresponds to the interface. The input device 2 supplies input information “S1” generated based on inputs of the user, to the information processing device 1.

The display device 3 is, for instance, a display, projector, or the like, which performs a predetermined display based on display information “S2” supplied from information processing device 1.

The storage device 4 is a memory which stores various sets of information necessary for an optimization process. For instance, the storage device 4 stores information (also called “problem designation information”) designating the combinatorial optimization problem to be solved by the information processing device 1, and a program for calculating a predetermined number of solutions for combinatorial optimization problem which is designated. The problem designation information includes information indicating conditions of the combinatorial optimization problem (including parameters related to problem setting) to be solved by the information processing device 1. At least a portion of the problem designation information may be generated based on the input information S1 which the input device 2 to be operated by the user generates.

Note that the storage device 4 may be a storage device such as a hard disk connected or built into the information processing device 1, or may be a storage medium such as a flash memory. The storage device 4 may be a server device that performs data communication with the information processing device 1. In this case, the storage device 4 may be formed by a plurality of server devices.

A configuration of the optimization system 100 depicted in FIG. 1 corresponds to an example, various changes may be made to this configuration. For instance, the input device 2 and the display device 3 may be formed as a single device. In this case, the input device 2 and the display device 3 may be formed as a tablet type terminal which is integrated with the information processing device 1. Moreover, the information processing device 1 may be formed by a plurality of devices. In this case, the plurality of devices forming the information processing device 1 exchange information necessary to execute a process assigned in advance among these devices.

### (2) Hardware Configuration of Information Processing Device

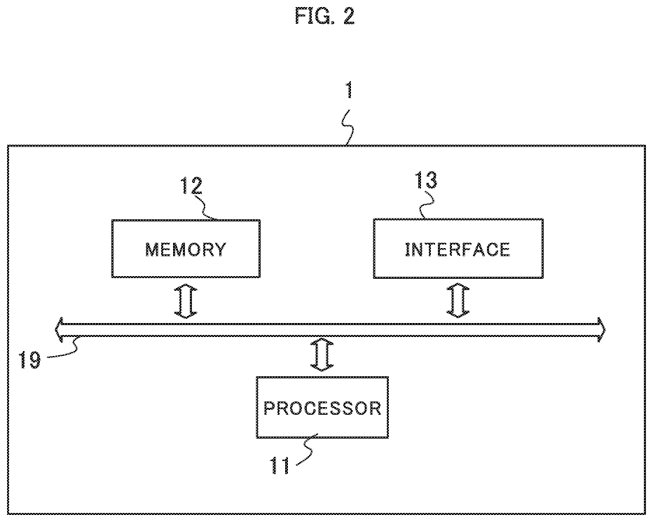

FIG. 2 illustrates a hardware configuration of the information processing device 1. The information processing device 1 includes a processor 11, a memory 12, and an interface 13 as hardware. The processor 11, the memory 12, and the interface 13 are connected via a data bus 19.

The processor 11 executes a predetermined process by executing a program stored in the memory 12. The processor 11 is a processor such as a CPU (Central Processing Unit), a GPU (Graphics Processing Unit), and a TPU (Tensor Processing Unit). The processor 11 may be formed by a plurality of processors. The processor 11 is an example of a computer.

The memory 12 is formed by various volatile memories such as a RAM (Random Access Memory) and a ROM (Read Only Memory) and a non-volatile memory. Moreover, programs for executing various kinds of processes by the information processing device 1 are stored in the memory 12. The memory 12 is used as a working memory to temporarily store information and the like which are acquired from the storage device 4. The memory 12 may function as the storage device 4. Similarly, the storage device 4 may function as the memory 12 of the information processing device 1. The program executed by the information processing device 1 may be stored in a storage medium other than the memory 12.

The interface 13 is an interface for electrically connecting the information processing device 1 with another device. The interface 13 may be a communication interface such as a network adapter for wired or wireless communication with the external device, or may be a hardware interface compliant with a USB (Universal Serial Bus), a SATA (Serial AT Attachment), or the like.

Note that the hardware configuration of the information processing device 1 is not limited to the configuration illustrated in FIG. 2. For instance, the information processing device 1 may include at least one of the input device 2 or the display device 3. Moreover, the information processing device 1 may be connected to or built into a sound output device such as a speaker.

### (3) Functional Block

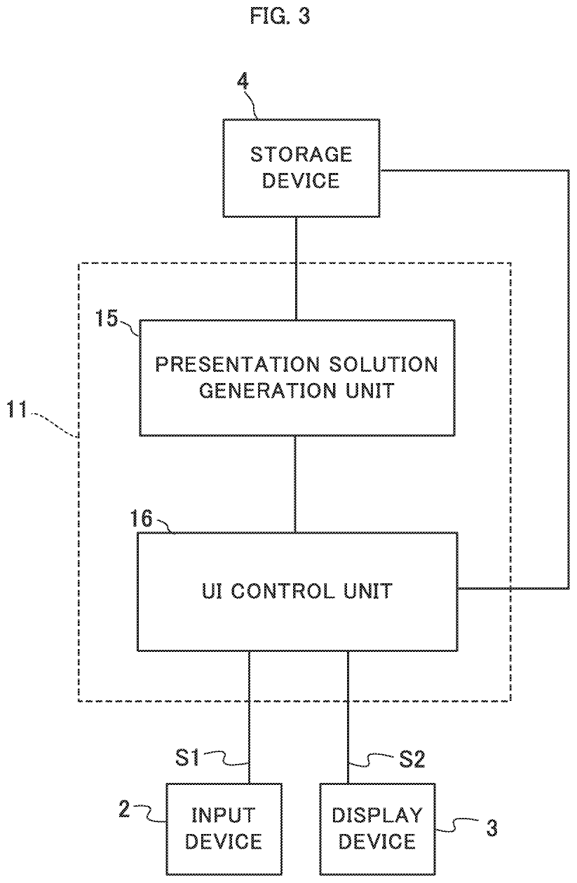

FIG. 3 illustrates an example of a functional block of the processor 11 in the first example embodiment. The processor 11 functionally includes a presentation solution generation unit 15 and a UI (User Interface) control unit 16. In FIG. 3, blocks for data exchange are connected by solid lines, but a combination of blocks for the data exchange is not limited to that depicted in FIG. 3. The same applies to the drawings of other functional blocks described below.

The presentation solution generation unit 15 generates “k” (k is an integer of two or more) solutions (also called “presentation solutions”) to be presented to the user among solutions of the designated combinatorial optimization problem. In this case, as will be described later, the presentation solution generation unit 15 determines k presentation solutions to be diverse solutions with variation. The presentation solution generation unit 15 supplies information concerning the generated presentation solutions to a UI control unit 16.

Note that presentation solutions represent matching in the designated combinatorial optimization problem; for instance, the presentation solutions indicate n pairs of sellers and buyers when there are n sellers and n buyers (n is an integer of two or more) to be matched. The combinatorial optimization problem in this case corresponds to a perfect matching of size n with n points on each of a right side and a left side in a complete bipartite graph. As described above, in the present example embodiment, as an example, the combinatorial optimization problem to be designated is a combinatorial optimization problem in which the solution is the perfect matching in the complete bipartite graph. Note that, the combinatorial optimization problem targeted in this disclosure are not limited to the problem which seeks the matching, and the target for seeking diverse solutions in this disclosure is not limited to the matching.

The UI control unit 16 performs a control to receive user inputs and display information to be viewed by the user. In this instance, the UI control unit unit 16 receives each user input necessary for generating the problem designation information or performs a display control of the display device 3 concerning the presentation solutions by supplying display information S2 to the display device 3, based on the input information S1 supplied from the input device 2. In the latter example, the UI control unit 16 generates the display information S2 concerning the k presentation solutions supplied by the presentation solution generation unit 15, and supplies the generated display information S2 to the display unit 3. A specific process of the UI control unit 16 will be described below with reference to the display example.

Note that for instance, the components of the presentation solution generation unit 15 and the UI control unit 16 described in FIG. 3 can be realized by the processor 11 which executes corresponding programs. Moreover, necessary programs may be recorded on any non-volatile storage medium and installed as necessary to realize each of the components. Note that at least a portion of each of these components may be implemented by any combination of hardware, firmware, and software, and the like, without limitation to realize these components by software with programs. Also, at least some of these components may also be implemented using a user programmable integrated circuitry such as, for instance, a FPGA (Field-Programmable Gate Array) or a microcontroller. In this case, the integrated circuit may be used to realize respective programs formed by the above components. Furthermore, at least a portion of the components may be formed by an ASSP (Application Specific Standard Produce), an ASIC (Application Specific Integrated Circuit, or a quantum processor (quantum computer control chip). Accordingly, each component may be implemented by various hardware. The above applies to other example embodiments described below as well. Furthermore, each of these components may be realized by the collaboration of a plurality of computers using, for example, cloud computing technology.

### (4) Generation of Presentation Solutions

Next, a method for generating the presentation solutions by the presentation solution generation unit 15 will be described. In this example embodiment, as an example, in a case of generating the perfect matching of the complete bipartite graph (perfect bipartite matching) as the presentation solutions, the presentation solution generation unit 15 generates k perfect bipartite matchings which are diverse in a sense of maximizing the minimum distance. Note that in the present disclosure, the target of seeking diverse solutions is not limited to the matching.

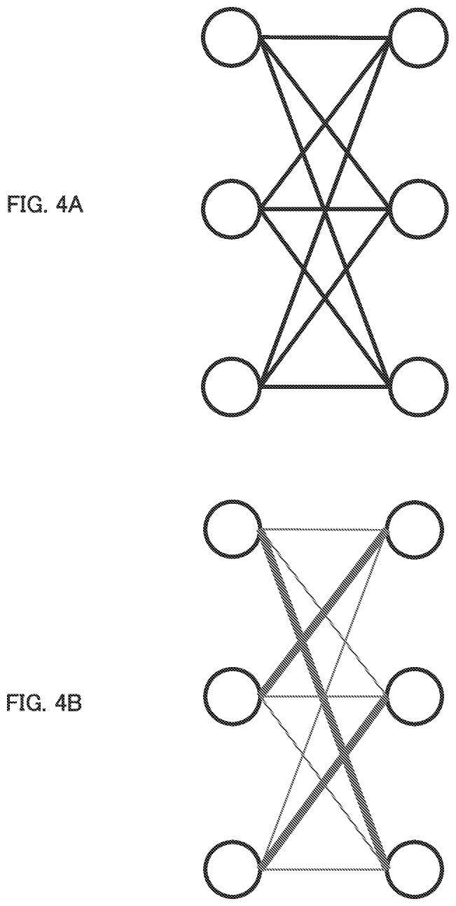

Here, a specific example of the perfect bipartite matching will be described. FIG. 4A illustrates the complete bipartite graph with three points at each of the right side and the left side, and FIG. 4B illustrates an example of the complete bipartite graph with three points at each of the right side and the left side depicted in FIG. 4A. Note that, in FIG. 4B, branches to be matched are represented by thick lines. The same applies to the drawings described below.

Next, a maximization of the minimum distance described above is described in detail using mathematical formulas. When the set of branches of the complete bipartite graph is denoted by “V”, a set family of perfect bipartite matchings is denoted by “S” (⊆2V), and a weight of each branch is denoted by “w”, in Si∈S (i=1, . . . , k) representing the k presentation solutions, the presentation solution generation unit 15 finds solutions which maximize the following formula (1).

$$[ Math 1 ]$$

$${min}_{i \neq j} {\sum }_{v ∈ {s}_{i} △ {s}_{j}} w ( v ) \qquad ( 1 )$$

This corresponds to finding the k solutions which maximize a minimum weighted Hamming distance between the solutions (that is, the set of pairs of nodes). Note that in a case of maximizing a sum of distances between solutions as in Non-Patent Document 1, it is possible to acquire the k presentation solutions containing solutions which are similar to each other (that is, presentation solutions which form two groups (clusters) which are far apart). On the other hand, in the present example embodiment, by approximately obtaining the maximization of the minimum distance between the solutions (that is, maximization of the formula (1)), it is possible to suitably prevent the k presentation solutions from containing solutions which are similar to each other as described above, and it is possible to suitably obtain the k presentation solutions in which any two solutions are not similar to each other. The weighted Hamming distance is an example of the “distance between the solutions”, and the k presentation solutions in which a minimum value of the weighted Hamming distance is approximately maximized correspond to examples of “candidates satisfying predetermined conditions”.

Here, parameters such as the weight w for each branch, the number of vertices n of one side of the perfect binary graph (a set of vertices with no branches in between), the number of presentation solutions k, a parameter δ to be described later are stored in the storage device 4 as the problem designation information. Note that the UI control unit 16 may display an input screen for receiving the user input for specifying each of the parameters described above on the display device 3, and may store the problem designation information indicating each of the parameters specified by the user input on the input screen in the storage device 4. Note that the weight w for each branch may be a value designated by the user, and may be a default value set to be a common value (for instance, “1”) in each branch in a case where the user does not particularly specify the weight w.

In the present example embodiment, the presentation solution generation unit 15 approximately obtains Si∈S (i=1, . . . , k) which maximizes the formula (1) by an algorithm using a framework of a MWU (Multiplicative Weight Update) which is a kind of a dual gradient method. In this case, the presentation solution generation unit 15 calculates Si∈S (i=1, . . . , k) in a probabilistic and approximate manner.

Note that, in general, for matching of size n in the perfect bipartite matching with n points on each of the right side and the left side, there are n! matching candidates. Accordingly, as n increases, the number of candidates for every matching increases dramatically.

In consideration of the above, in the present example embodiment, the presentation solution generation unit 15 emphasizes an efficiency of the algorithm, and approximately obtains Si∈S (i=1, . . . , k) which maximizes the formula (1) by the algorithm using the framework of the MWU (also referred to as a “MWU based algorithm”).

Next, the MWU based algorithm will be described in detail. In the MWU based algorithm, a branch set V, the weight w, the number of solutions k, and the parameter δ (>0) are input, and S1, . . . , Sk are output. Moreover, here, it is assumed that when the subset V of the branch set V is given, there exists an oracle which is capable of efficiently determining whether or not the subset V is included in the set family S. Note that in order to determine whether the given branch set V is the perfect matching in the complete bipartite graph of a target, it is sufficient to determine that there is exactly one branch connected to each vertex (for instance, if there is a vertex that is not a vertex where exactly one branch is connected, then it is not a perfect match at that point); accordingly, it is possible to determine whether it is the perfect matching or not by confirming state for each vertex.

First, the presentation solution generation unit 15 arbitrarily determines S1∈S. The presentation solution generation unit 15 may determine S1∈S based on any combinatorial optimization algorithm and may select from the family of set S by a random method. Next, the presentation solution generation unit 15 determines S1, . . . , Sk by sequentially executing the following algorithm (also referred to as a “S1 determination sub-algorithm”) which is a sub-algorithm in MWU based algorithm for determining S1∈S for (1=2, . . . , k).

Next, the S1 determination sub-algorithm will be described. In the S1 determination sub-algorithm, the branch set V, the weight w, an index 1, the parameter δ (>0), and the presentation solutions S1 which are previously determined and input, and S1 is output by executing processes (a first step to a fourth step) described below. Moreover, here, it is assumed that when the subset V of the branch set V is given, there exists the oracle which is capable of efficiently determining whether or not the subset V is included in the set family S.

First, as the first step, the presentation solution generation unit 15 determines “T”, “η”, “β(1)”, and “γ(1)” as follows.

$$[ Math 2 ]$$

$$T := max \{ ⌈ \frac{4 {\vert V \vert}^{2} {W}^{2} log ( l - 1 )}{{6}^{2}} ⌉ , 1 \} , n := min \{ \frac{1}{2} , \frac{δ}{2 \vert V \vert W} \}$$

$${β}^{( 1 )} = 1 \text{?} {γ}^{( 1 )} = \frac{1}{l - 1} 1$$

$$\text{?} \text{indicates text missing or illegible when filed}$$

Here, “W” in the above formula is calculated based on the following formula.

$$[ Math 3 ]$$

$$W := {max}_{υ ∈ V} w ( υ )$$

Next, as a second step, for each of t=1, . . . , T−1, the following process A, process B, and process C are executed.

As the process A, the presentation solution generation unit 15 takes S(t)∈S for which the following formula (2) is equal to or greater than “p” times the maximum value. Here, the process A is to be performed by an existing solver or the like.

$$[ Math 4 ]$$

$${\sum }_{i = 1}^{l - 1} {γ}_{i}^{( t )} {d}_{w} ( {S}^{( t )} , {S}_{i} ) \qquad ( 2 )$$

Here, “dw” denotes the weighted Hamming distance between solutions and is expressed by the following formula.

$$[ Math 5 ]$$

$${d}_{w} ( {S}_{i} , {S}_{j} ) := {\sum }_{υ ∈ {S}_{i} △ {S}_{j}} w ( υ )$$

Next, as the process B, the presentation solution generation unit 15 calculates β based on the following formula (3) for each of i=1, . . . 1-1.

$$[ Math 6 ]$$

$${β}_{i}^{( t + 1 )} = {β}_{i}^{( t )} ( 1 − η \cdot \frac{{d}_{w} ( {S}^{( t )} , {S}_{i} )}{\vert V \vert W} ) \qquad ( 3 )$$

Furthermore, as the process C, the presentation solution generation unit 15 calculates γ based on the following formula (4) for each of i=1, . . . , 1-1.

$$[ Math 7 ]$$

$${γ}_{i}^{( t + 1 )} = {β}_{i}^{( t + 1 )} / {\sum }_{{i}^{′} = 1}^{l = 1} {β}_{{i}^{′}}^{( t + 1 )} \qquad ( 4 )$$

Then, as the third step, the presentation solution generation unit 15 S(t)∈S for which the following formula (5) is equal to or greater than p times the maximum value.

$$[ Math 8 ]$$

$${\sum }_{i = 1}^{l - 1} {γ}_{i}^{( T )} {d}_{w} ( {S}^{( T )} , {S}_{i} ) \qquad ( 5 )$$

Note that, the algorithm that approximates S(T)∈S such that the formula (5) attains the maximum value is an algorithm used in the process A of the second step, and is an algorithm where the formula (5) is guaranteed to be at least p times the maximum value.

Next, as the fourth step, the presentation solution generation unit 15 selects S(t) as S1 by a probability proportional to a frequency of an occurrence at t=1, . . . , T. Subsequently, the presentation solution generation unit 15 executes a S1 determination sub-algorithm including the first step to the fourth step described above for each of 1=2, . . . , k. Accordingly, it is possible for the presentation solution generation unit 15 to probabilistically and approximately calculate Si∈S (i=1, . . . , k) so as to maximize the formula (1).

Here, the nature of the presentation solutions output by the above-described MWU based algorithms will be supplementary described.

For the maximization of the formula (2) and formula (5) described above, it is assumed that a feasible solution to an objective function value that is u times the maximum value can be found in efficient time within a range desired by the user. Moreover, a weighted maximization over the set family S based on the formula (1), it is assumed that an optimal value of an optimal solution is “Ψ”. In this case, a property presented in the formula (6) below is guaranteed.

$$[ Math 9 ]$$

$${min}_{1 \leq i < j \leq k} {d}_{w} ( {S}_{i} , {S}_{j} ) \geq \frac{μ}{2} Ψ − δ \qquad ( 6 )$$

Note that “E” in the formula (6) represents an expected value for a probabilistic element of the MWU-based algorithm described above.

As described above, it is possible for the presentation solution generation unit 15 to determine diverse presentation solutions with theoretical guarantee, by using the MWU based algorithm.

Next, a specific example of the generation of the presentation solution will be described.

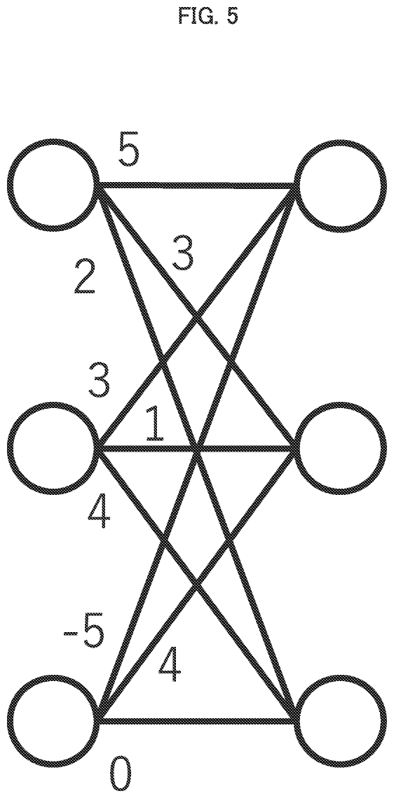

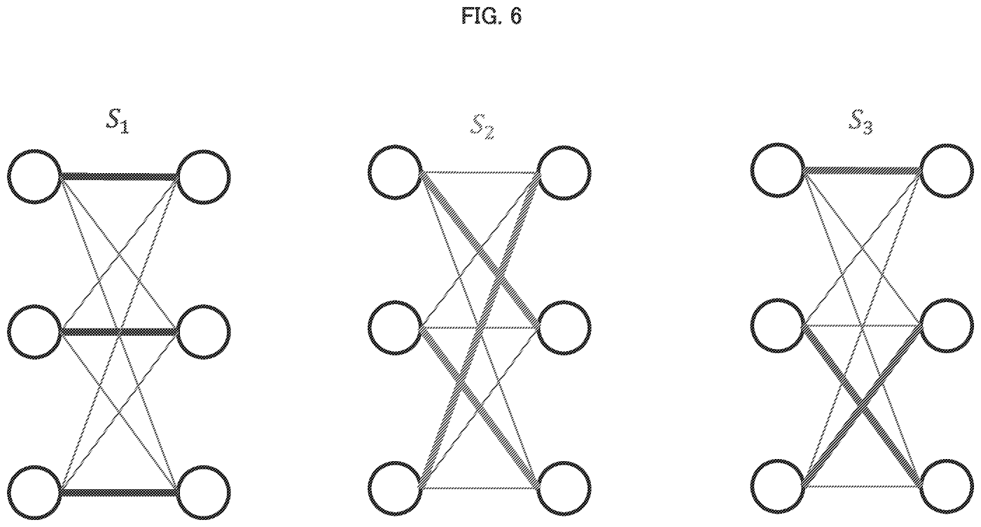

FIG. 5 is a diagram illustrating the weight w for each branch in the complete bipartite graph with three points at each of the right side and the left side. In this case, the branch set V is a set of nine branches in the graph, and the set family S is a set family of all perfect bipartite matchings. Then, FIG. 6 illustrates presentation solutions S1, S2, and S3 which are output when the MWU based algorithm is executed as “k=3” and “δ=4” in the complete bipartite graph illustrated in FIG. 5.

In this case, first, the presentation solution unit 15 determines S1∈S by any method. After that, the presentation solution generation unit 15 probabilistically and approximately calculates S1∈S (i=1, 2, 3) which maximizes the formula (1), by executing the S1 determination sub-algorithm for “1=2” and “1=3”.

Here, by the S1 determination sub-algorithm at “1=2”, “T=1” is acquired. Therefore, in this case, the presentation solution generation unit 15 selects S(1) as S2, since there is only one solution where S(T)∈S (that is, S(1) alone) as the candidate to be selected in the third step.

Moreover, by the S1 determination sub-algorithm at “1=3”, “T=351” is acquired. Therefore, in this case, the presentation solution generation unit 15 acquires 351 (that is, S(1) to S(351)) solutions to select as candidates in the third step. Accordingly, the presentation solution generation unit 15 selects S3 from S(1) to S(351) with equal probability in the third step.

### (5) Display Example

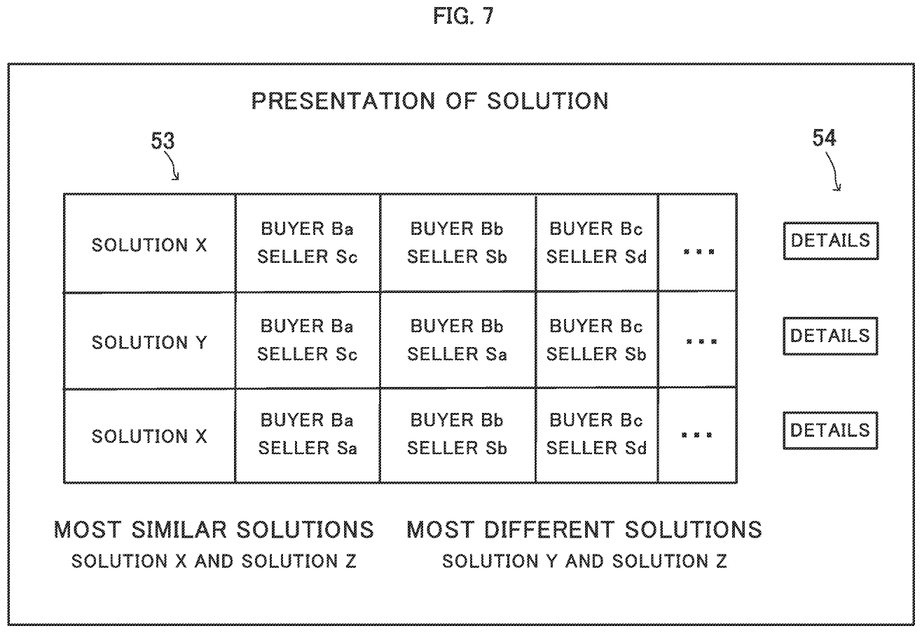

FIG. 7 is a display of a presentation solution display screen which is a screen to be displayed on the display device 3 by the UI control unit 16. The UI control unit 16 generates the display information S2 for displaying the presentation solution display screen based on a process result generated by the presentation solution generation unit 15 and sends the generated display information S2 to the display device 3 through the interface 13, thereby causing the display device 3 to display the presentation solution display screen. Here, the matching of buyers (Ba, Bb, Bc, . . . ) and sellers (Sa, Sb, Sc, . . . ) is designated as the combinatorial optimization problem to be solved. Also, in this example, it is assumed that k=3.

The UI control unit 16 displays a presentation solution table 53 representing the combination of the sellers and the buyers based on presentation solutions (a solution X, a solution Y, a solution Z, . . . ) determined by the presentation solution generation unit 15, on the presentation solution display screen. The presentation solution table 53 has a record for each presentation solution, and a detail button 54 is provided with each record for viewing detailed information concerning the corresponding solution.

Also, in a space below the presentation solution table 53, the UI control unit 16 clearly indicates that a pair of the most similar solutions (that is, a pair of solutions with the smallest weighted Hamming distance) indicates the solution X and the solution Z. In this way, UI control unit 16 can make the user grasp the pairing of the most similar solutions. Similarly, in the space below the presentation solution table 53, the UI control unit 16 clearly indicates that the most different solution pair (that is, a pair of solutions having the largest weighted Hamming distance) is the solution Y and the solution Z. By this manner, it is possible for the UI control unit 16 to make the user grasp the pair of the most distinct solutions.

### (6) Process Flow

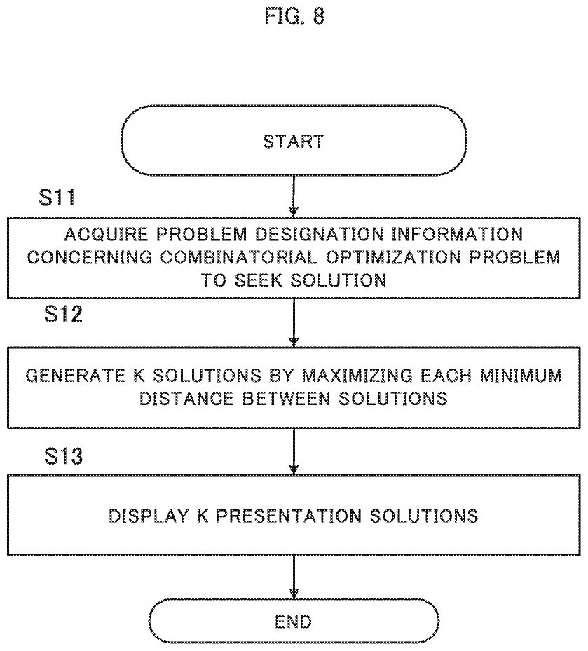

FIG. 8 is an example of a flowchart which the information processing device 1 executes in the first example embodiment.

First, the information processing device 1 acquires the problem designation information in which the combinatorial optimization problem for seeking the solutions is designated (step S11). In this case, the information processing device 1 acquires the problem designation information generated based on the input information S1 stored in advance in the storage device 4 or supplied by the input device 2. Thus, the information processing device 1 acquires the branch set V, the weight w, the number of presentation solutions k, the parameter δ, and the like. Moreover, it is assumed that there exists the oracle which can efficiently determine whether the subset V is included in the set family S when the subset V of the branch set V is given.

Next, the information processing device 1 generates k solutions by maximizing the minimum value of the distance between the solutions (step S12). In this case, the information processing device 1 calculates k presentation solutions (S1 ∈S (i=1, . . . , k)) which approximately maximize the formula (1) probabilistically by the MWU based algorithm. Therefore, it is possible to determine diverse presentation solutions with theoretical guarantees (see the formula (6)).

Then, the information processing device 1 displays the information concerning the presentation solutions determined in step S12 on the display device 3 (step S13). Accordingly, it is possible for the information processing device 1 to present diverse solutions to the user, and prompt the user to make a decision.

### Second Example Embodiment

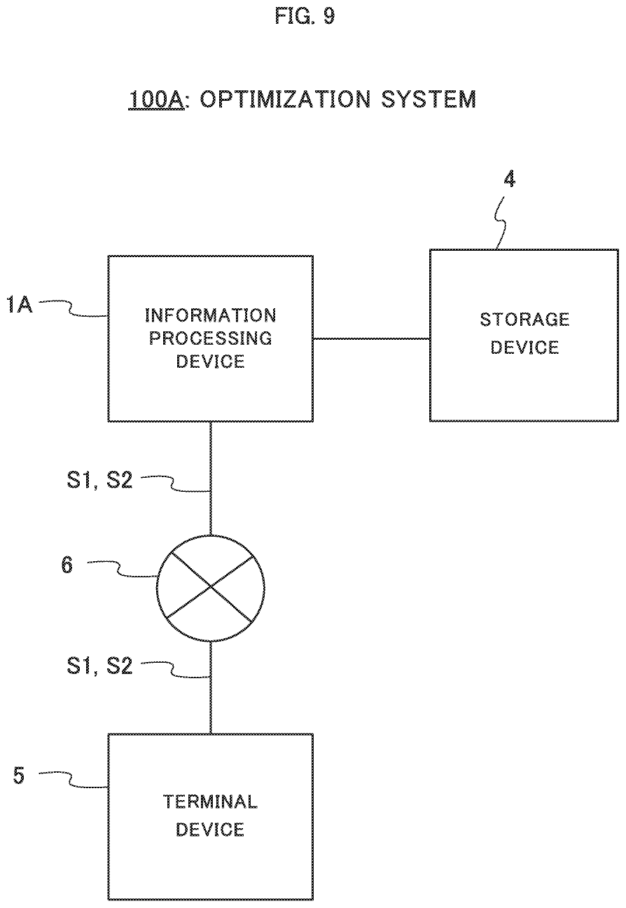

FIG. 9 illustrates a configuration of an optimization system 100A in a second example embodiment. As illustrated in FIG. 9, the optimization system 100A mainly includes an information processing device TA, a storage device 4, and a terminal device 5. The information processing device TA and the terminal device 5 perform data communications via a network 6.

The information processing device TA performs a process concerning the optimization executed by the information processing device 1 in the first example embodiment. In this case, the information processing device TA receives, from the terminal device 5 via the network 6, the input information S1 which the information processing device 1 receives from the input device 2 in the first example embodiment. Moreover, the information processing device TA sends the display information S2 which the information processing device 1 sends to the display device 3 in the first example embodiment, to the terminal device 5 via the network 6. Accordingly, the information processing device TA according to the second example embodiment functions as a server device.

The terminal device 5 is a terminal including an input function, a display function, and a communication function, and functions as the input device 2 and the display device 3 in the first example embodiment. The terminal device 5 may be, for instance, a personal computer, a tablet type terminal, a PDA (Personal Digital Assistant), or the like. The terminal device 5 sends the input information S1 generated based on the received user input to the information processing device TA via the network 6. In addition, when the display information S2 is received from the information processing device TA, the terminal device 5 displays the presentation solution display screen or the like based on the display information S2.

The information processing device TA according to the second example embodiment can suitably execute the input process and the display process which are executed by the information processing device 1 in the first example embodiment, for the user of the terminal device 5.

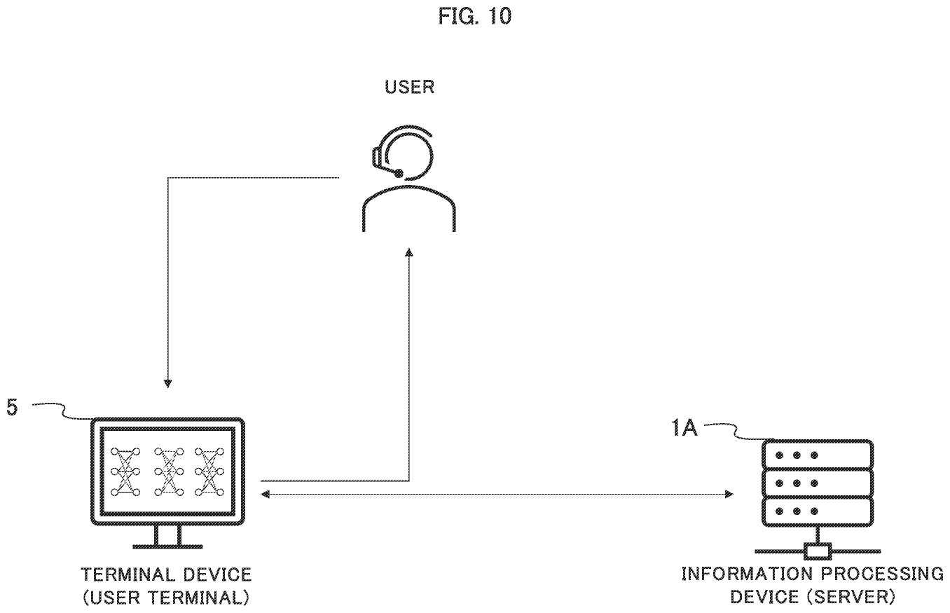

FIG. 10 is a diagram illustrating each relationship among a user, the information processing device TA, and the terminal device 5 in the second example embodiment. As illustrated in FIG. 10, the information processing device TA functions as a server which executes an algorithm, and the terminal device 5 functions as a user terminal which accepts inputs of parameters and the like required for the algorithm. Next, the terminal device 5 exchanges information with the information processing device TA, and displays the presentation solution display screen or the like illustrating the diverse presentation solutions to the user. Note that the terminal device 5 may accept an input for evaluating the diversity of the pairs of the presentation solutions, and sends information indicating an evaluation result to the information processing device TA as feedback information. In this case, the information processing device TA may accumulate the feedback information received from the terminal device 5, and use the accumulated feedback information for training of a model or the like for calculating the diverse presentation solutions.

Moreover, similar to the first example embodiment, the use case illustrated in FIG. 10 can encourage the user to make a decision by presenting the diverse presentation solutions with theoretical guarantees.

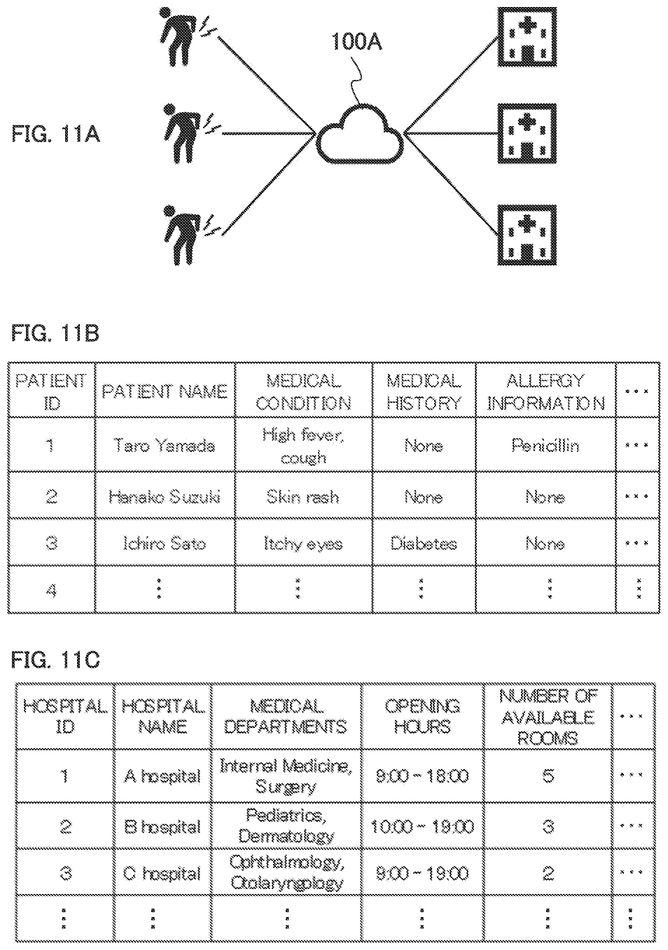

Here, as an application example, a matching problem between patients and hospitals will be described. FIG. 11A is a diagram illustrating a schematic of the matching problem between the patients and the hospitals. Here, the optimization system 100A includes patient information concerning a plurality of patients who desire to be admitted in a hospital and hospital information concerning a plurality of hospitals which can accept patients, and matches between the patients and the hospitals based on the patient information and the hospital information. Next, the optimization system 100A presents a diverse matching proposal for the best hospital to which each patient is be admitted. Note that, this application example is similarly applicable to the optimization system 100 of the first example embodiment.

FIG. 11B is an example of a data structure of the patient information, and FIG. 1C is an example of a data structure of the hospital information. The patient information illustrated in FIG. 11B includes a record for each patient including a patient ID, a patient name, a medical condition, medical history, and allergy information. Such patient information is generated, for instance, by each patient registering information concerning health of the patient (the medical condition, the medical history, and the allergy information) in the optimization system 100A. The hospital information illustrated in FIG. 1C includes a record for each hospital including information such as a hospital ID, a hospital name, a medical department, opening hours, the number of available rooms, and the like. Such hospital information is generated, for instance, by a person in charge of each hospital registering information concerning each of the aforementioned items in the optimization system 100A.

In this application, the objective function may be, for instance, a function related to a total distance to the hospital for each patient, a function related to a total waiting time for each patient, a function related to the number of matchings, or a function combining these functions. In addition, examples of constraints set in this application are illustrated as follows:
The medical department that the patient desires to visit is provided by the hospital.
Ensure that the hospital does not exceed its capacity.
Patients are able to be seen during consultation hours of the hospital.
The appointment date desired by the patient is a business day of the hospital.
Patient has or does not have a specific infectious disease.
A referral letter from a family physician must be presented.

According to this application, the optimization system 100A matches the patients with the hospitals so that an appropriate acceptance for the patients by the hospitals is achieved, and displays the presentation solution display screen or the like presenting diverse matching results to the patients or administrators who assign the patients to the hospitals. Accordingly, it is possible for the optimization system 100A to smoothly carry out an appointment for each patient with the hospital.

### Third Example Embodiment

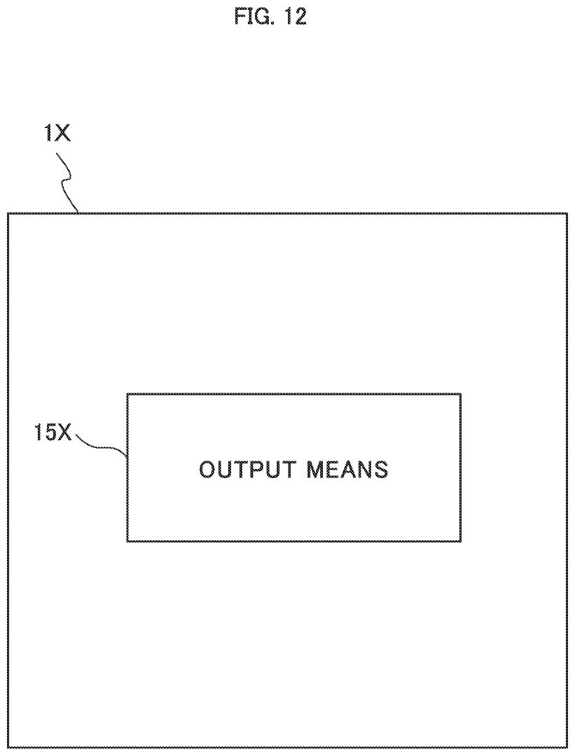

FIG. 12 is a functional block diagram of an information processing device 1X according to a third example embodiment. The information processing device 1X mainly includes an output means 15X. The information processing device 1X may be formed by a plurality of devices.

In a case of outputting a predetermined number of solutions from a plurality of solutions in an optimization problem, from candidates for selecting the predetermined number of solutions, the output means 15X outputs candidates in which the minimum value of the distance between the solutions satisfies a predetermined condition as the predetermined number of solutions. The output means 15X can be the presentation solution generation unit 15 or/and the UI control unit 16 in the first example embodiment or the second example embodiment. Note that “outputting” is not limited to displaying the predetermined number of solutions on a display device or the like, but may also include sending the predetermined number of solutions to another device (including storing the predetermined number of solutions in an external or internal memory device). Moreover, “solution of a predetermined number” is, for instance, the “k presentation solutions” in the first example embodiment or the second example embodiment, the “distance between solutions” may be, for instance, the “Weighted Hamming distance” in the first example embodiment or the second example embodiment.

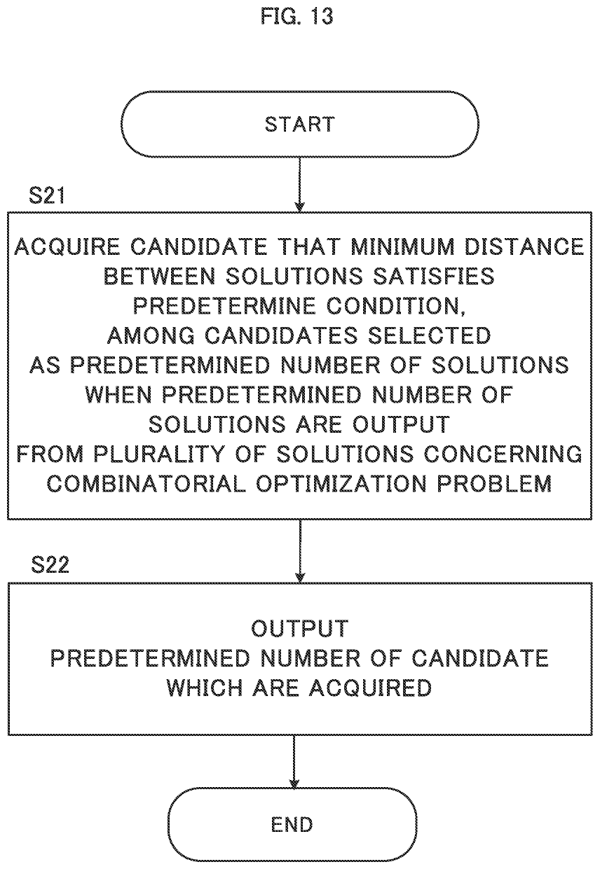

FIG. 13 illustrates an example of flowchart which is performed by the information processing device 1X in the third example embodiment. The output means 15X acquires candidates in which the minimum value of the distance between the solutions satisfies the predetermined condition among candidates used to select the predetermined number of solutions, when outputting the predetermined number of solutions, from the plurality of solutions in the optimization problem (step S21). After that, the output means 15X outputs the acquired candidates as the predetermined number of solutions (step S22).

Accordingly, it is possible for the information processing device 1X according to the third example embodiment to suitably output the predetermined number of solutions with diversity when outputting the plurality of solutions in the optimization problem.

In addition, some or all of the above-described example embodiments (including modifications, the same applies hereinafter) may also be described as follows, but are not limited to the following.

### (Supplementary Note 1)

An information processing device comprising:
an output means configured to output, as a predetermined number of solutions, candidates in which a minimum value of a distance between the solutions satisfies a predetermined condition among candidates used to select the predetermined number of solutions, when outputting the predetermined number of solutions, from a plurality of solutions in an optimization problem.

### (Supplementary Note 2)

The information processing device according to supplementary note 1, wherein the output means outputs candidates in which the minimum value of the distance between the solutions is approximately maximized, as candidates satisfying the predetermined condition.

### (Supplementary Note 3)

The information processing device according to supplementary note 2, wherein the output means determines the candidates in which the minimum value of the distance between the solutions is approximately maximized, based on a Multiplicative Weight Update.

### (Supplementary Note 4)

The information processing device according to supplementary note 1, wherein
the optimization problem is a combinatorial optimization problem which solution is a perfect matching of a complete bipartite graph, and
the distance between the solutions is a Hamming distance.

### (Supplementary Note 5)

The information processing device according to supplementary note 4, wherein
each branch of the complete bipartite graph is weighed, and
the distance between the solutions is the weighted Hamming distance.

### (Supplementary Note 6)

The information processing device according to supplementary note 1, wherein the output means controls displaying the predetermined number of solutions.

### (Supplementary Note 7)

The information processing device according to supplementary note 6, wherein the output means sends display information for displaying the predetermined number of solutions to a terminal device used by the user, based on a request from the terminal device used by the user.

### (Supplementary Note 8)

An output method performed by a computer, the output method comprising:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.

### (Supplementary Note 9)

A recording medium storing a program, the program causing a computer to perform a process comprising:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.

In the example embodiments described above, the program is stored by any type of a non-transitory computer-readable storage medium (non-transitory computer readable storage medium) and can be supplied to a processor or the like that is a computer. The non-transitory computer-readable storage medium include any type of a tangible storage medium. Examples of the non-transitory computer readable storage medium include a magnetic storage medium (that is, a flexible disk, a magnetic tape, a hard disk drive), a magnetic-optical storage medium (that is, a magnetic optical disk), a CD-ROM (Read Only Memory), a CD-R, a CD-R/W, a solid-state memory (that is, a mask ROM, a PROM (Programmable ROM), an EPROM (Erasable PROM), a flash ROM, a RAM (Random Access Memory)). The program may also be provided to the computer by any type of a transitory computer readable storage medium. Examples of the transitory computer readable storage medium include an electrical signal, an optical signal, and an electromagnetic wave. The transitory computer readable storage medium can provide the program to the computer through a wired channel such as wires and optical fibers or a wireless channel.

While the present disclosure has been described with reference to the example embodiments, the present disclosure is not limited to the above example embodiments. Various modifications that can be understood by a person skilled in the art within the scope of the present disclosure can be made to the configuration and details of the present disclosure. That is, the present disclosure includes, of course, various modifications and modifications that may be made by a person skilled in the art according to the entire disclosure and technical concepts including the scope of claims. Furthermore, each disclosure of the above-mentioned patent and non-patent documents cited shall be incorporated by reference herein.

### DESCRIPTION OF SYMBOLS

1, 1A, 1X Information processing device
2 Input device
3 Display device
4 Storage device
5 Terminal device
100, 100A Optimization system

What is claimed is:

1. An information processing device comprising:
a memory storing instructions; and
one or more processors configured to execute the instructions to:
output, as a predetermined number of solutions, candidates in which a minimum value of a distance between the solutions satisfies a predetermined condition among candidates used to select the predetermined number of solutions, when outputting the predetermined number of solutions, from a plurality of solutions in an optimization problem.

2. The information processing device according to claim 1,
wherein the processor outputs candidates in which the minimum value of the distance between the solutions is approximately maximized, as candidates satisfying the predetermined condition.

3. The information processing device according to claim 2, wherein the processor determines the candidates in which the minimum value of the distance between the solutions is approximately maximized, based on a Multiplicative Weight Update.

4. The information processing device according to claim 1, wherein
the optimization problem is a combinatorial optimization problem which solution is a perfect matching of a complete bipartite graph, and
the distance between the solutions is a Hamming distance.

5. The information processing device according to claim 4, wherein
each branch of the complete bipartite graph is weighed, and
the distance between the solutions is the weighted Hamming distance.

6. The information processing device according to claim 1, wherein the processor controls displaying the predetermined number of solutions.

7. The information processing device according to claim 6, wherein the processor sends display information for displaying the predetermined number of solutions to a terminal device used by the user, based on a request from the terminal device used by the user.

8. An output method performed by a computer, the output method comprising:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.

9. A non-transitory computer-readable recording medium storing a program, the program causing a computer to perform a process comprising:
acquiring candidates in which a minimum value of a distance between the solutions satisfies a predetermined condition among candidates used to select the predetermined number of solutions, when outputting the predetermined number of solutions, from a plurality of solutions in an optimization problem; and
outputting the candidates which are acquired, as a predetermined number of solutions.
